(19) United States
(12) Patent Application Publication
(10) Pub. No.: US 2005/0217481 A1
(43) Pub. Date: Oct. 6, 2005

(54) Rotary adsorbent contactors for drying, purification and separation of gases

(76) Inventors: Stephen R. Dunne, Algonquin, IL (US); Peter K. Coughlin, Mundelein, IL (US); Rustam H. Sethna, Palatine, IL (US); Keith R. Clark, Houston, TX (US)

Correspondence Address: JOHN G TOLOMEI, PATENT DEPARTMENT;UOP LLC, 25 EAST ALGONQUIN ROAD, P O BOX 5017, DES PLAINES, IL, 60017-5017, US

(21) Appl. No.: 10/815,245

(22) Filed: Mar. 31, 2004

(51) Int. Cl. B01D 53/02

(52) U.S. Cl. 95/113

(57) ABSTRACT

One or more continuous rotary contactors, also known as adsorbent wheels, containing adsorbent materials are employed to dry, purify or separate components from a gas stream. The invention has particular application in treating air prior to cryogenic air separation operations.

### BACKGROUND OF THE INVENTION

The present invention relates to processes and equipment for gas purification, and more particularly to a gas purification method and apparatus using rotary contactors. More particularly, this invention relates to the use of rotary adsorbent contactors to remove impurities from a gas feed stream prior to compression of the gas feed stream.

It is often necessary to remove impurities from a gas stream. There are a variety of gases that require treatment prior to their use or further processing, including air and natural gas. Air plant purification, instrument air drying, and air brakes are a few important examples of processes in which air needs to have one or more impurities removed prior to further processing or use of the air. Natural gas may require removal of water and carbon dioxide. Other gaseous hydrocarbon streams may also require purification. Conventional air separation units for the production of nitrogen and oxygen by the cryogenic separation of air are basically comprised of a two-stage distillation column, which operate at very low temperatures. In addition to the desired products (e.g., nitrogen, oxygen, argon), the air that is used as a starting material for cryogenic processing contains impurities or undesirable components such as water vapor, carbon dioxide and hydrocarbon species. Due to the extremely low temperatures, it is essential that water vapor and carbon dioxide be removed prior to an air stream entering an air separation unit. These impurities must be removed before processing of feed air can be completed because the impurities interfere with continuous and efficient operation of the cryogenic equipment and present operational safety issues. If water and carbon dioxide are not removed, then the low temperature sections of the air separation unit may freeze necessitating a halt to production during which the frozen sections need to be warmed. It is generally recognized that in order to prevent the freezing of the air separation unit, that the content of water vapor and carbon dioxide in the compressed air feed stream must be less than 0.1 ppm and 1.0 ppm respectfully.

The current commercial methods for the purification of gases include reversing heat exchangers, temperature swing adsorption and pressure swing adsorption. In many instances, a chiller precedes the adsorption system to remove much of the moisture and reduce the resulting load on the adsorption system. This system then provides a dried, clean air stream to the plant. The cooled, compressed feed air is passed through an adsorbent material. This cooled air still needs to be cooled further to cryogenic temperatures before it is fed to a cryogenic separation system. Temperature swing adsorption (TSA) pre-purification works by removing impurities at relatively low temperatures, typically about 5° C. and regeneration is carried out at elevated temperatures, typically about 150° to 250° C. The amount of product gas required for regeneration is typically only about 12 to 15%, a significant improvement over reversing heat exchangers. However, TSA processes often require both refrigeration units to chill the feed gas and heating units to heat the regeneration gas. This results in undesirable energy usage as well as high capital costs.

Pressure swing adsorption (PSA) processes are an attractive alternative to TSA processes since in PSA processes both the adsorption and regeneration steps are carried out at ambient temperature. The PSA systems are generally the preferred technology, although the type of product and other considerations usually determine the choice of system. However, PSA processes usually do require substantially more regenerative gas (25 to 40% of the feed) than do TSA processes, which can be disadvantageous when high recovery of cryogenically separated products is desired. This disadvantage can be substantially reduced in a cryogenic plant which has a substantial waste stream comprising typically 40% of the feed. Such waste streams can be ideal for regeneration gas since they are free of water vapor and carbon dioxide and were to be vented in any case. However, there are high capital and energy costs associated with PSA systems. TSA systems are extremely effective at removing the major contaminants, such as water, carbon dioxide and most of the hydrocarbons from an air feed because such adsorbers usually employ strong adsorbents. Therefore, they are preferred for high purity applications. The strong adsorbents used in TSA processes, such as 5A or 13X zeolite require the large thermal driving forces available by TSA to affect adequate desorption. The operating adsorbate loadings and selectivities of the major contaminants on these strong adsorbents is such that carbon dioxide breaks through into the product stream before acetylene and most other hydrocarbons that are harmful to cryogenic air separation plant operation, such as the C₃ through C₈ hydrocarbons. The feed gas is usually chilled to minimize the water content of the feed, which in turn reduces the amount of adsorbent required. While the TSA process results in a relatively low purge to feed ratio, the inherent heating of the purge and chilling of the feed adds to both the capital and operating cost of the process. PSA prepurifiers use a near-ambient temperature purge to regenerate the adsorption beds. The reduced driving force that is available from pressure swing alone requires a weaker adsorbent (such as alumina), shorter cycles and higher purge to feed ratios compared to TSA processes in order to achieve adequate desorption of water and carbon dioxide contaminants. Typical purge to feed ratios are 40 to 60% in PSA prepurification. Unfortunately, weak adsorbents such as activated alumina are unable to sufficiently retain light hydrocarbons such as acetylene in a reasonable size bed and ethane breaks through into the product stream ahead of carbon dioxide. This leads to a potentially hazardous operating condition in a cryogenic air separation process. While the capital costs associated with a PSA prepurifier are lower than those of a TSA, the overall power requirement can be higher. In particular, blowdown or depressurization losses increase power consumption in the PSA prepurifiers. PSA units cycle much faster than TSA units, resulting in an increase in the frequency of blowdown loss steps. Accordingly, there remains a need for a system for prepurification that requires lower levels of capital, lowered energy costs and lowered use of gas that has been purified as a source of regeneration.

Another use for dry air is for use by equipment or machinery. The current practice is to first compress the air and then treat it to remove water and other contaminant vapors and gases. In this practice, a dryer containing the appropriate adsorbent is placed downstream from an air compressor and a portion of the compressed air is used as a regeneration medium for the dryer. In thermal swing adsorption (TSA) drying, a portion of the product gas is heated and then used as a regeneration medium. Similarly, in pressure swing adsorption (PSA), a portion of the product gas together with the adsorbent bed are opened to a lower pressure and the expanded gas carries away the contaminants. In both the TSA and PSA systems, the energy used in compressing a portion of the gas has been lost when that portion is used for regeneration instead of remaining with the bulk of the compressed air for use in equipment or machinery.

Rotary adsorbent contactors have been developed for several applications including heating and air conditioning as well as VOC concentration, prior to their destruction. They have been used in dehumidification or desiccant wheels, enthalpy control wheels and open cycle desiccant cooling systems.

Most applications of desiccant wheel technology, particularly in the heating and air conditioning field have focused on bulk drying of air where the humidity of the incoming air is reduced from near saturation by a factor of about 2. A relative humidity of about 80% at ambient temperature would be reduced in such a way that the water content is cut by a factor of 2 to 3. The result in such bulk drying applications is that there is an inevitable gain in sensible heat associated with passing air through an essentially adiabatic drying operation and the temperature rise further lowers the relative humidity of the product stream. However, desiccant wheels have not previously to the present invention been used in applications requiring very dry, pure air, such as air prepurification and instrument air drying.

U.S. Pat. No. 5,632,802 describes one system for drying air at ambient conditions prior to its entry into an air compressing machine. This system comprises desiccant bed adsorption units for removal of water prior to compression of the air.

U.S. Pat. No. 4,769,053 discloses a sensible and latent heat exchange membrane that comprises a gas permeable matrix. An inlet air stream flows in one direction, while the exhaust air stream flows in the opposition direction through different portions of the wheel. The wheel has a corrugated sheet material that contains an adsorbent powder.

In the field of VOC control rotary contactors have been used for concentration of the VOCs prior to their removal. In U.S. Pat. No. 6,080,227, a honeycomb rotor is used in the concentration of VOC. This rotor is described as having disposed thereon a cooling zone, a desorbing zone and an adsorbing zone. The rotor rotates and thus passes through each of the zones in turn.

U.S. Pat. No. 5,788,744 discloses a method of recirculating a portion of the desorption outlet gas in a rotary concentrator to reduce the amount of desorption gas which must be treated at a final processing step.

U.S. Pat. No. 6,051,050 describes a rotor for use in a PSA process for separation of components of a feed gas.

U.S. 2001/0027723 A1 discloses the use of an adsorbent material that is monolithic having a plurality of channels that are aligned in the direction of the flow of a gaseous mixture. This monolithic bed is used to separate the components of the gaseous mixture. This reference does not disclose the use of rotary adsorbent contactors for such applications.

The use of high surface area materials for use as adsorbents is well known in the art. High surface area activated carbon is one well known type of adsorbent, and it has extensive commercial application as an adsorbent. Among these high surface area materials which have gained considerable commercial use are the inorganic oxides. In particular silica gel, activated alumina, and zeolites are used as adsorbents.

Zeolites are crystalline aluminosilicates with complex three dimensional infinite lattices. While some commercially used zeolites are natural minerals, most commercial zeolite adsorbents are produced synthetically. They are normally synthesized containing cations from group IA or IIA of the Periodic Table, in particular sodium, potassium, magnesium, and calcium. Chemically, zeolites are often represented by the empirical formula:
M_{2/n}OAl₂O₃.ySiO₂.wH₂O
whereby y is 2 or greater, n is the valence of the cation M, and w represents the water contained in the voids of the zeolite.

Zeolites are often classified by their crystal structure. The International Zeolite Association maintains a listing of known zeolite structure, and assigns the well known three letter designation for the structure. Commercially important zeolites include, zeolite A, described in U.S. Pat. No. 2,882,243, and given the designation LTA, and zeolite X described in U.S. Pat. No. 2,882,244, and zeolite Y, described in U.S. Pat. No. 3,130,007, both of which have the structure of the mineral faujasite, and have the designation, FAU, but with different ratios of silicon and aluminum in the framework lattice.

It is well known that the cations in the zeolite can be replaced by other cations by an ion exchange process. The affinity of a zeolite for a particular cation is known to vary with the structure, and the ratio of silicon and aluminum in the framework. The affinity of the zeolite for the cation determines the conditions needed to obtain the amount of exchange desired in the zeolite.

Many of these ion exchanged forms of zeolites are used as commercially. The potassium form of LTA, known as 3A because the pore opening of the zeolite is reduced to approximately 3 angstroms, is often used as an adsorbent. It has gained favor over the sodium form of LTA, known as 4A, in drying the air space between dual pane windows because unlike 4A, its reduced pore size will not allow 3A to adsorb air at low temperature. The calcium exchanged form of LTA, 5A, is favored in iso-normal paraffin separations where a slightly larger pore size improves performance.

Many ion exchanged forms of FAU are also known. DDZ-70 is a rare earth exchanged form of FAU available from UOP LLC, Des Plaines, Ill.

In the present invention, a gas is dried and otherwise treated at ambient pressure with rotary adsorbent contactors before it enters a compressor. Energy consuming components downstream of the compression stages are thereby eliminated. Also, in the case of air being treated, by lowering the dew point of the air before compression, the compressor produces air at dew points which meet or exceed the capabilities of current compressed air drying equipment.

The components that can be eliminated in connection with air drying operations include aftercoolers, moisture separators, compressed air dryers and oil/water separators. Aftercoolers, moisture separators and air dryers create pressure drops in a compressed air system. These pressure drops require energy to overcome losses. Energy is saved both through the elimination of components such as air cooled aftercoolers and air dryers and by the more efficient operation of air compressors through the use of dry compressing air.

Environmental benefits are also realized in elimination of refrigerated type compressed air dryers that use chlorofluorocarbon refrigerants which are damaging to the earth's ozone layer. A further advantage of the drying of the air prior to compression is that oil lubricated compressors may contaminate the gas flow with compressor oil. Moisture separators and refrigerated air dryers then produce condensate which is contaminated with this compressor oil. If this condensate is not eliminated properly or if an oil/water separator is not used to scrub the condensate of oil, the condensate can cause contamination such as to the ground and groundwater supplies. Also, the condensate can produce a burden on wastewater treatment facilities if the condensate is introduced into a sewage system. Since the air is dry when it leaves the compressor, no condensate is formed.

### SUMMARY OF THE INVENTION

The present invention comprises at least one rotary adsorbent contactor to purify a gas stream. The number of rotary adsorbent contactors is dependent upon the particular application which determines the purity of gas that is necessary. At least one rotary adsorbent contactor is used with additional contactors added in certain applications.

One embodiment of the invention comprises a process of producing compressed gases comprising first removing impurities from a gas by passing said gas through at least one rotary adsorbent contactor in a direction parallel to an axis of rotation of said rotary adsorbent contactor wherein said rotary adsorbent contactor comprises an adsorbent material and then compressing said first gas.

Another embodiment of the invention comprises a system for drying and compressing gases, such as air or natural gas, comprising at least one rotary adsorbent contactor comprising at least one adsorbent material, connections to allow purified gas to flow from the rotary adsorbent contactor to a compressor.

In yet another embodiment, the invention comprises a method of purifying a gas comprising passing said gas through a plurality of rotary adsorbent contactors wherein said method comprises passing said gas through at least one rotary adsorbent contactor to remove moisture and to cool said stream, and a rotary adsorbent contactor to remove other impurities from said gas. Additional rotary adsorbent contactors may be used to achieve higher levels of purity.

Another embodiment of the invention comprises a process for ultra-purification of a feed stream containing one or more contaminant species, the process comprising passing a feed stream containing one or more contaminant species across a first continuously rotating rotary adsorbent contactor. The first rotary adsorbent contactor is regenerated by passing a suitable regeneration gas stream through a sector of the first rotary adsorbent after which the rotary adsorbent contactor is prepared for passage of said the stream by passing a suitable gas stream through a sector of the rotary adsorbent contactor, and then the feed stream is partially purified after passage through the rotary adsorbent contactor. Then the partially purified feed stream is passed to at least one feed sector of a second rotary adsorbent contactor to further purify the feed stream, with regeneration of the second rotary adsorbent contactor by passing a suitable regeneration gas stream through a sector of said second rotary adsorbent contactor. Following the regeneration of the second rotary adsorbent contactor, the second rotary adsorbent contactor is prepared for passage of the feed stream by passing a suitable gas stream through a sector of the second rotary adsorbent contactor, and the feed stream is further purified after passage through said rotary adsorbent contactor. The further purified feed stream is then passed to at least one feed sector of a third rotary adsorbent contactor and the third rotary adsorbent contactor is regenerated by passing a suitable regeneration gas stream through a sector of the third rotary adsorbent contactor and following regeneration of the third rotary adsorbent contactor, the third rotary adsorbent contactor is prepared for passage of the feed stream by passing a suitable gas stream through a sector of the third rotary adsorbent contactor.

In another embodiment of the invention is provided a process for producing a purified gas stream. In this process first the contaminants are adsorbed by passing a feed gas stream through a sector of a continuously rotating rotary adsorbent contactor, followed by regenerating the rotary adsorbent contactor by passing a regeneration gas stream through a second sector of the continuously rotating rotary adsorbent contactor then by preparing the rotary adsorbent contactor for adsorption of said contaminants from said feed gas stream, wherein said preparation is done by passing a preparation gas stream through a third sector of said continuously rotating rotary adsorbent contactor.

### BRIEF DESCRIPTION OF THE DRAWINGS

FIG. 1 shows the zones on a rotary adsorbent contactor.

FIG. 2 is a rotary adsorbent contactor system with cocurrent regeneration.

FIG. 3 is a rotary adsorbent contactor system with cocurrent cooling.

FIG. 4 is a rotary adsorbent contactor system with all gas flows cocurrent.

FIG. 5 is a rotary adsorbent contactor system with all gas flows cocurrent with an added heat exchanger for the regeneration gas flow.

FIG. 6 is a rotary adsorbent contactor system with the adsorbent gas flow and the cooling gas flow current and with an added heat exchanger for the regeneration gas flow.

FIG. 7 provides for a minor portion of the purified gas flow to be diverted to be the regeneration gas flow.

FIG. 8 provides for a minor portion of the purified gas flow to be diverted to be the cooling gas flow.

FIG. 9 provides for minor portions of the purified gas flow to be diverted to be regeneration and cooling gas flows.

FIG. 10 provides a system cocurrently cooled with the adsorption step.

FIG. 11 provides a three rotary adsorbent contactor system for providing very pure gas.

FIG. 12 provides an alternate embodiment of a three rotary adsorbent contactor system for providing very pure gas.

FIG. 13 provides an alternate embodiment of a two rotary adsorbent contactor system with mixture of outside air in a boost blower.

### DETAILED DESCRIPTION OF THE INVENTION

In accordance with the present invention, a rotary adsorbent contactor (also known as an adsorbent wheel or desiccant wheel in some applications) is employed to dry, purify or separate components from a gas stream. A continuous system is thereby provided for the purification of a gas stream that is to be compressed or used in other applications.

The integration of the upstream dryer and the compressor offers an opportunity to reduce energy consumption associated with the compression and purification of gas. In many applications including air plant prepurification and instrument air drying, two or more stages of compression are normally used to achieve the final product pressure required by the application. Gas inter-coolers are typically employed to manage the temperature of the product gas. Use of the energy, ordinarily released to the ambient or to cooling water, as a heat source for regeneration is a means of saving substantial quantities of energy. Prepurification of air prior to air separation by cryogenic means is a particularly useful application of the present invention.

In those applications in which air is the gas to be purified and compressed, at least one and preferably at least two rotary adsorbent contactors may be employed with different adsorbent materials and different process schemes for operation. There are several different types of rotary adsorbent contactors that may be used in the present invention. One type is a rotary heat and mass exchanger that treats incoming air continuously using a countercurrent stream of gas that is a cleaner, dryer and/or cooler gas than the incoming air to be treated. Such a device has application in managing the load on a downstream dryer or purifier. Reduction of either contaminant level or temperature relative to the incoming air stream can provide a benefit. Reductions in water content by a factor of two or more can be achieved by use of this heat and mass exchange device. Such devices are referred to in the HVAC industry as “enthalpy control wheels”. A second type of device is a deep dehumidification wheel employing an adsorbent with an isotherm shape that is ideally suited for water removal. One or more wheels of this nature can be used in series to dry air to extremely low dew points. When extremely dry air is needed, it may be advantageous to use two dehumidification wheels with a heat exchange device interposed in between the two wheels in order to remove a portion of the sensible heat gain caused by drying of air in the first wheel. If the load reduction by the first wheel is sufficient, there is generally no need to cool the product of the second rotary adsorbent contactor. A third type of device used in the present invention is a rotary adsorbent contactor where the adsorbent is chosen for its affinity towards some contaminant other than water. An example is a rotary adsorber using an adsorbent that is useful in removing various inorganic or organic contaminants. Such a rotary adsorbent contactor may be used to take the product from the dehumidification rotary adsorber and further remove traces of water and carbon dioxide or other contaminants. While some of the adsorbents may be quite selective for water, it is also desirable to select adsorbents that have a pronounced affinity and capacity for inorganic contaminants when the water content of the stream is low. N₂O, NO₂, SO₂, H₂S, HCl are among the contaminants that can be trapped by rotary adsorbent contactors.

In one embodiment of the invention, a gas separation system is used for obtaining oxygen and nitrogen products employing a rotary adsorbent contactor system for air prepurification. A series of three rotary contactors is preferred, including an enthalpy rotary adsorbent contactor, a deep desiccant rotary adsorbent contactor and a 13X rotary adsorbent contactor. The enthalpy rotary adsorbent contactor removes most of the moisture and cools the air stream into the rotary adsorbent contactor. The deep desiccant rotary adsorbent contactor serves to further lower the dew point of the air flow and the 13X rotary adsorbent contactor removes carbon dioxide as well as virtually all of the remaining moisture. The feed air is passed through an enthalpy rotary adsorbent contactor, deep desiccant rotary adsorbent contactor and 13X rotary adsorbent contactor in series. The feed air then passes through a series of heat exchangers and coolers to be brought to the appropriate temperature for separation. Nitrogen and oxygen product is separated cryogenically at this point. A portion of the nitrogen product returns to cool the rotary adsorbers to operating temperatures. A regenerative gas flow passes countercurrently through a sector of the rotary adsorbent contactors to desorb carbon dioxide and water.

The adsorbent used in the present invention is at least one adsorbent selected from the group consisting of rare earth exchanged faujasite, calcium exchanged faujasite, H+ exchanged faujasite, silica gel, alumina and mixtures thereof.

### DETAILED DESCRIPTION OF THE FIGURES

The drawings illustrate a number of embodiments of the invention.

FIG. 1 shows a depiction of the zones on a rotary adsorbent contactor. For ease of illustration, in FIGS. 1-13, the blocks show the three main zones of the rotary adsorber, with vertical arrows to show the direction in which the contactor is turning as well as the order in which the gas streams contact the rotary adsorbent contactor. For example, in FIG. 1, a surface of the rotary adsorbent contactor is first exposed to a gas stream passing through an adsorption zone to remove impurities, then the surface is exposed to a heated regeneration stream to desorb impurities from the rotary adsorbent contactor's adsorbent and finally the surface is exposed to a cooler gas stream to cool the rotary adsorbent contactor and ready it for the adsorption zone again (signified by the A in a circle at the bottom of the Figure). In order to be consistent throughout the figures, the letters A, R and C represent the adsorption zone, the regeneration zone and the cooling zone, respectively of a rotary adsorbent contactor. In those figures that have more than one rotary adsorbent contactor, the zones in the first rotary adsorbent contactor have a subscript one, the zones in the second rotary adsorbent contactor have a subscript two and the zones in the third rotary adsorbent contactor, if applicable, have a subscript three. In each figure, the adsorption zone is shown as a significantly larger area than each of the regeneration zone and the cooling zone.

In FIG. 1, gas flow 1 approaches and passes through the media of adsorption zone A of rotary adsorbent contactor 7 which removes impurities from the gas flow and produces purified gas flow 2 which can now be used as needed or purified further. Approaching the regeneration zone in a direction countercurrent to gas flow 1 is regeneration gas 3, which is at a higher temperature than gas flow 1. Regeneration gas 3 contacts regeneration zone R, removing impurities and continues as impure stream 4, which can be purged from the system or the impurities can be removed, such as through condensation of condensible impurities through use of a condenser (not shown). Cooling gas 5, at a lower temperature than regeneration gas 3, passes through cooling zone C to cool the rotary adsorbent contactor and then passes through and is shown as stream 6.

FIG. 2 depicts a similar system to FIG. 1, except now the regeneration gas flow is cocurrent to the gas flow passing through the adsorption zone A. Gas flow 11 passes through adsorption zone A of rotary adsorbent contactor 10 and is shown as purified gas stream 12. Regeneration gas flow 13 contacts regeneration zone R and then as impure stream 14. Cooling stream 15 contacts cooling zone C and then proceeds as gas stream 16 through cooling zone C. The vertical arrows indicate the direction of the revolution of the rotary adsorbent contactor with first the gas flow to be purified contacting adsorption zone A, then the regeneration gas flow contacting regeneration zone R and finally the cooling gas flow contacting cooling zone C.

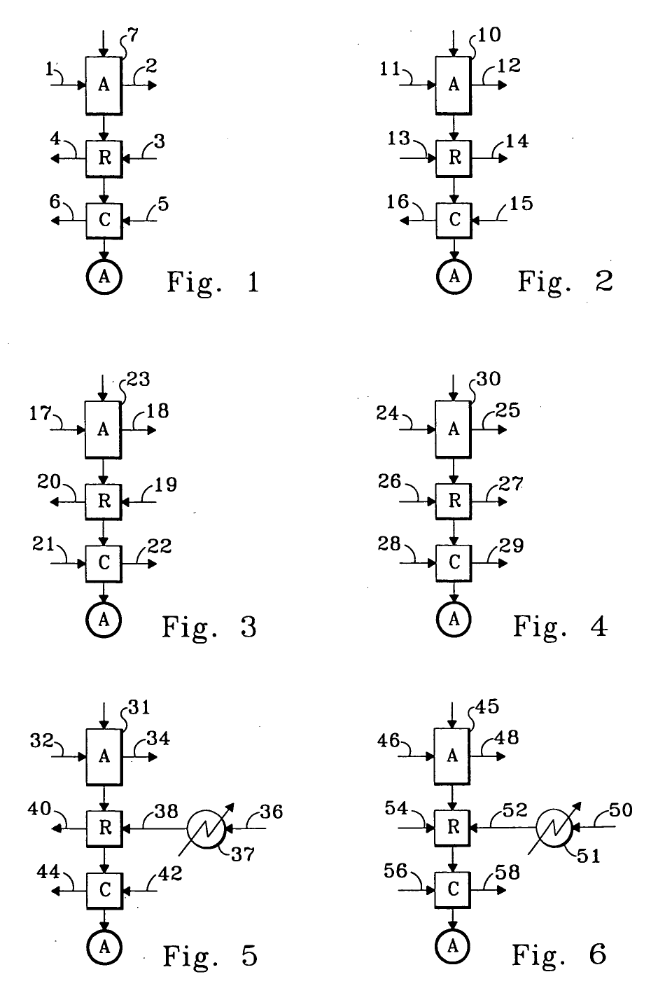

FIG. 3 shows a cooling gas flow cocurrent to the gas flow to be purified and countercurrent to the regeneration gas flow. Gas stream 17 contacts adsorption zone A of rotary adsorbent contactor 23 and is then purified gas stream 18 as it exits rotary adsorbent contactor 23. Regeneration gas flow 19 is at a higher temperature than gas stream 17 and desorbs impurities from regeneration zone R, then shown leaving regeneration zone R as gas stream 20. Cooling gas stream 21 contacts cooling zone C and leaves as gas stream 22. The vertical arrows depict the revolving of the adsorbent wheel as explained with FIGS. 1 and 2.

FIG. 4 is an alternate embodiment of the invention with all three of the gas flows cocurrent. Gas stream 24 passes through adsorption zone A of rotary adsorbent contactor 30 producing purified gas stream 25; regeneration gas stream 26 passes through regeneration zone R resulting in gas stream 27 with the removed impurities; and cooling gas stream 28 passes through cooling zone C and continues as gas stream 29.

FIG. 5 is similar to FIG. 1 as to having regeneration and cooling gas stream countercurrent to the gas flow to be purified. In addition, FIG. 5 shows a heat exchanger to heat up the regeneration gas flow to an adequate temperature to desorb impurities within regeneration zone R on the rotary adsorbent contactor 31. Incoming gas stream 32 is shown contacting adsorption zone A of rotary adsorbent contactor 31 and then proceeding as a product gas flow 34. Regeneration gas flow 36 is heated by a heat exchanger 37 with the resulting heated gas stream 38 contacting and removing impurities from regeneration zone R and then continuing as gas stream 40 to be purified or vented as waste gas. Cooling gas flow 42 is shown contacting and cooling the cooling zone C of the adsorbent wheel and then continuing as gas stream 44. The vertical arrows depict the direction of the rotary adsorbent contactor rotation as explained with FIGS. 1 and 2.

FIG. 6 is similar to FIG. 5, except for the direction of the cooling flow being cocurrent to the gas flow contacting adsorption zone A of rotary adsorbent contactor 45. Incoming gas stream 46 is shown contacting adsorption zone A with purified gas stream 48 becoming the product gas. Regeneration gas stream 50 is heated at heat exchanger 51, having a source of heat not shown in this figure. Heated gas flow 52 contacts regeneration zone R to desorb impurities from the surface of the rotary adsorbent contactor 45 and then continues as gas stream 54 to be vented or the impurities removed, as desired. Cooling gas-stream 56 contacts cooling zone C and then is shown proceeding as gas stream 58. The rotary adsorbent contactor 45 rotates in a direction consistent with the vertical arrows shown in the figure.

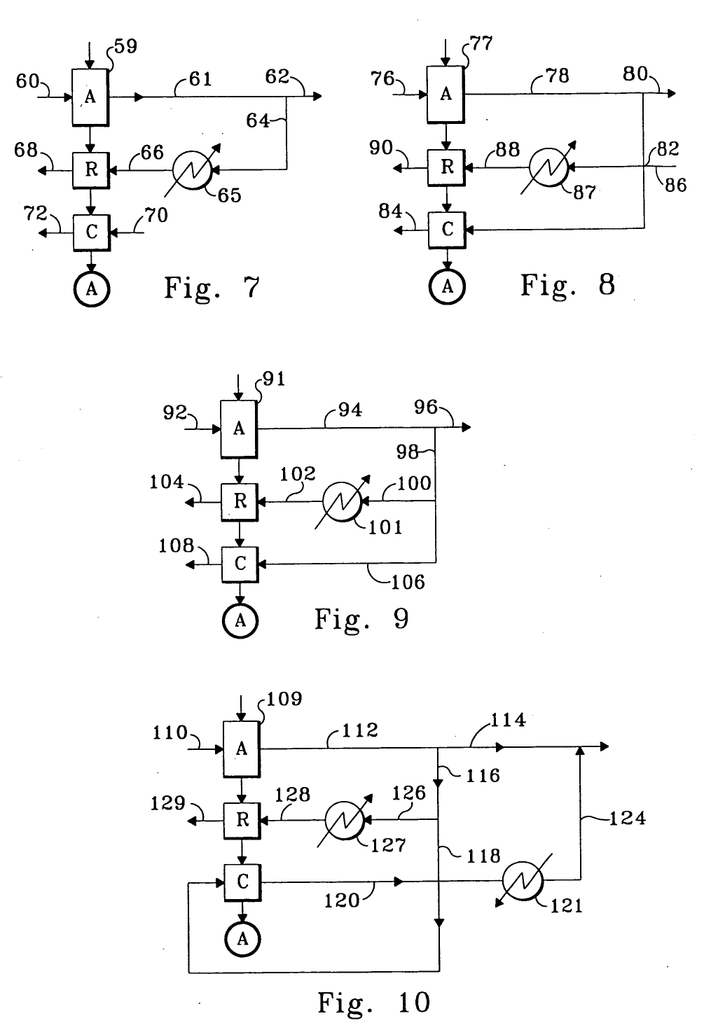

In FIG. 7, a minor portion of the purified gas stream is diverted to be heated and become the regeneration gas stream. In FIG. 7, gas stream 60 is shown contacting adsorption zone A of rotary adsorbent contactor 59 resulting in purified gas stream 61, divided into a major portion 62 of net product gas and a minor portion 64 of regeneration gas to be heated at heat exchanger 65. Heated regeneration gas 66 contacts regeneration zone R and becomes gas stream 68 that contains the desorbed impurities from regeneration zone R. Cooling gas stream 70 contacts and cools cooling zone C of the rotary adsorbent contactor 59 and then is shown as gas stream 72 leaving cooling zone C. The rotary adsorbent contactor 59 rotates in a direction consistent with the vertical arrows shown in the figure.

In FIG. 8, a minor portion of the purified gas flow is diverted to be cooled and become the cooling gas stream. In FIG. 8, gas stream 76 is shown contacting adsorption zone A of rotary adsorbent contactor 77 resulting in purified gas stream 78, divided into a major portion 80 of net product gas and a minor portion 82 of cooling gas stream to contact and cool cooling zone C of the adsorbent wheel with the cooling stream continuing as gas stream 84. Regeneration gas 86 is heated by heat exchanger 87 and then heated regeneration gas 88 contacts regeneration zone R and becomes gas stream 90 that contains the desorbed impurities from regeneration zone R.

In FIG. 9, two minor portions of the purified gas flow are diverted from the product gas, one of which is the regeneration gas and the other is the cooling gas. In FIG. 9, gas stream 92 is shown contacting adsorption zone A of rotary adsorbent contactor 91 resulting in purified gas flow 94, divided into a major portion 96 of net product gas and minor portion 98 of purified gas. Purified gas 98 is then split into a regeneration gas stream 100 and a cooling gas stream 106. Regeneration gas stream 100 is heated by heat exchanger 101, becoming heated regeneration gas flow 102 contacting regeneration zone R and becoming gas flow 104 that contains the desorbed impurities from regeneration zone R. Cooling gas stream 106 contacts and cools cooling zone C of the rotary adsorbent contactor 91 and then is shown as gas flow 108 leaving cooling zone C. The rotary adsorbent contactor 91 rotates in a direction consistent with the vertical arrows shown in the figure.

FIG. 10 shows a system cooled by gas flowing cocurrently with the adsorption step. Gas flow 110 is shown contacting adsorption zone A of rotary adsorbent contactor 109 resulting in purified gas flow 112, divided into a major portion 114 of net product gas and minor portion 116 of purified gas. Purified gas 116 is then split into a regeneration gas flow 126 and a cooling gas flow 118. Regeneration gas flow 126 is heated by heat exchanger 127, becoming heated regeneration gas flow 128 contacting regeneration zone R and becoming gas flow 129 that contains the desorbed impurities from regeneration zone R. Cooling gas flow 118 contacts and cools cooling zone C of the rotary adsorbent contactor 109 and then is shown as gas flow 120 leaving cooling zone C. Gas flow 120 is cooled at a heat exchanger 121 and the heated gas flow 124 is re-combined with the stream 114 and taken as net product. The rotary adsorbent contactor 109 rotates in a direction consistent with the vertical arrows shown in the figure.

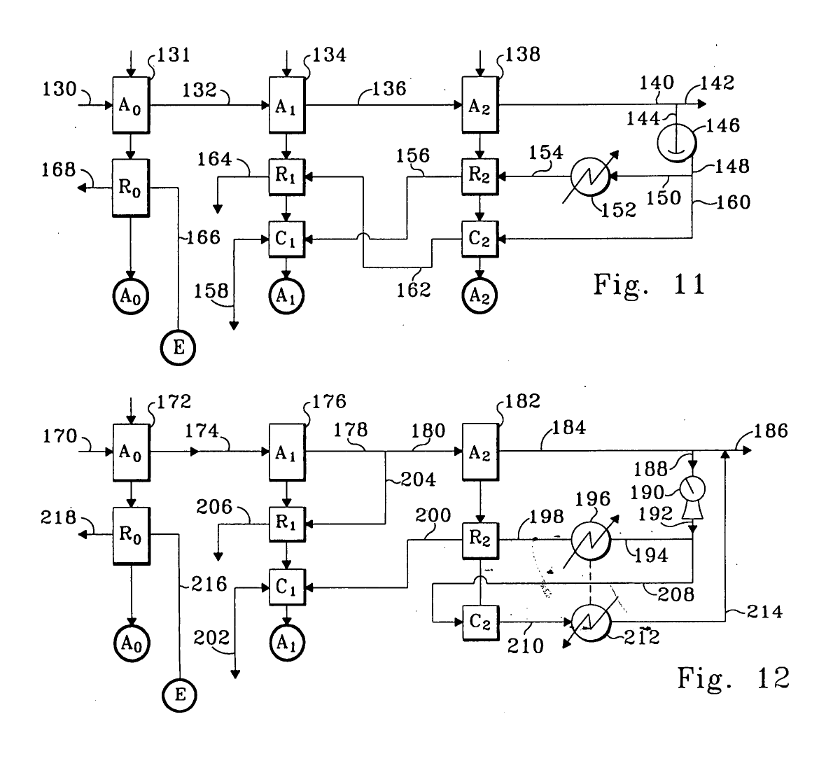

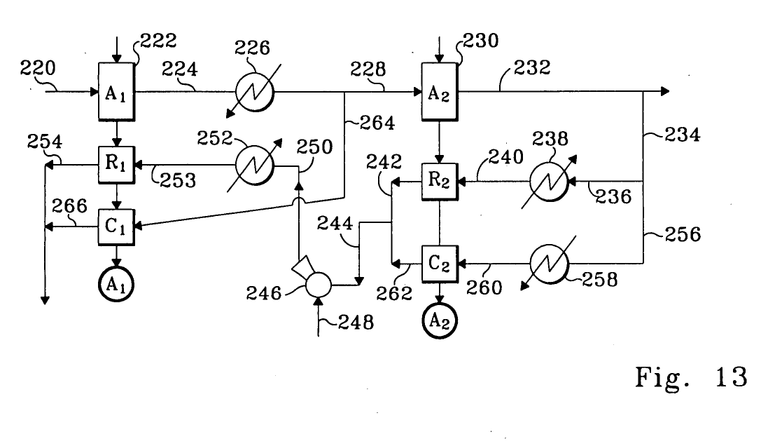

FIGS. 11 and 12 show two embodiments of the invention using a three rotary adsorbent contactor system to produce very pure gas, such as for an air prepurification system. In FIG. 11, gas stream 130 is shown contacting adsorption zone A₀ of a first rotary adsorbent contactor 131 to remove water from the gas. A gas stream 132 then passes through adsorption zone A₁ of second rotary adsorbent contactor 134 to significantly reduce the remaining water content in the gas stream. The gas stream continues as gas stream 136 to contact adsorption zone A₂ of rotary adsorbent contactor 138 containing an adsorbent selective for removal of carbon dioxide and water from the gas stream to produce very pure product gas stream 140 that is divided into major product gas stream 142 and minor gas stream 144. A blower 146 is shown to maintain the pressure in the system with gas stream 148 exiting the blower 146. Gas stream 148 is divided into a regenerating gas stream 150 that is heated at heat exchanger 152 and becomes heated regenerating gas stream 154 to pass through regeneration zone R₂ of the third rotary adsorbent contactor 138 to remove the carbon dioxide and water adsorbed thereon and to continue as gas stream 156 that is at a low enough temperature to be a cooling gas stream for cooling zone C₁ of the second rotary adsorbent contactor 134 and then exit cooling zone C₁ as gas stream 158 seen exiting the system. Gas stream 160 passes through cooling zone C₂ of the third rotary adsorbent contactor 138 and the exiting gas flow 162 passes through regeneration zone R₁ of the second rotary adsorbent contactor 134 exiting as gas flow 164 that exits the system. In this embodiment is seen an external regenerating gas stream 166 (labeled with an “E) passing through regeneration zone R₀ of the first rotary adsorbent contactor 131 and exiting as gas stream 168.

In FIG. 12, gas stream 170 is shown contacting adsorption zone A₀ of a first rotary adsorbent contactor 172 to remove water from the gas. Gas stream 174 then passes through adsorption zone A₁ of a second rotary adsorbent contactor 176 to significantly reduce the remaining water in the gas stream. The gas stream continues as gas stream 178 and is divided into a major portion 180 and a minor portion 204. Major portion gas stream 180 contacts adsorption zone A₂ of rotary adsorbent contactor 182 containing an adsorbent selective for removal of carbon dioxide and water from the gas stream to produce the very pure product gas stream 184 that is divided into major product gas stream 186 and minor gas stream 188 that passes through blower 190 that is shown to maintain the pressure in the system with gas stream 192 exiting the blower 190. Gas stream 192 is divided into a regenerating gas stream 194 and cooling gas stream 208. Regenerating gas stream 194 is heated at heat exchanger 196 and becomes heated regenerating gas stream 198 to pass through regeneration zone R₂ of third rotary adsorbent contactor 182 to remove the carbon dioxide and water adsorbed thereon and to continue as gas stream 200 that is at a low enough temperature to be a cooling gas stream for cooling zone C₁ of the second rotary adsorbent contactor 176 and then exit cooling zone C₁ as gas stream 202. Minor portion 204 of the gas stream passes through regeneration zone R₁ of second rotary adsorbent contactor 176 exiting as gas flow 206 seen exiting the system. Gas stream 208 passes through cooling zone C₂ of the third rotary adsorbent contactor 182 and the exiting gas flow 210 passes through heat exchanger 212 that may be optionally linked to heat exchanger 196 to conserve energy. This gas stream 214, which is a pure product gas stream, is combined with the product gas stream 186. Also shown is an external stream of air that is introduced as gas stream 216 (labeled with an “E) to regenerate regeneration zone R₀ of rotary adsorbent contactor 172 and exit as gas stream 218 after desorbing impurities from the regeneration zone. This is a process to produce extremely pure gas for gas separation operations.

FIG. 13 illustrates a system with two rotary adsorbent contactors in which the regenerating and cooling streams from the second rotary adsorbent contactor are combined, heated and used to regenerate the adsorbent in the first rotary adsorbent contactor. In FIG. 13, a flow of gas, preferably air, is shown entering the system at gas stream 220 to pass through adsorption zone A₁ of rotary adsorbent contactor 222. Purified gas 224 is cooled, as necessary, by heat exchanger 226 and then continues as gas stream 228 to adsorption zone A₂ of second rotary adsorbent contactor 230. The product gas flow that has been further purified is shown at gas stream 232, the majority of which is compressed or otherwise available for use. A portion of gas stream 232 is diverted as gas stream 234. The majority of gas stream 234 is diverted as gas flow 236, heated by heat exchanger 238 and as heated gas stream 240 passes through regeneration zone R₂. After passing through regeneration zone R₂, gas stream 242 is combined with gas stream 262 to become gas stream 244 to pass through boost blower 246 with additional fresh air shown entering the boost blower as fresh air stream 248. The gas stream that has been boosted in pressure proceeds as gas stream 250 to be heated by heat exchanger 252 and then as gas stream 253 to pass through regeneration zone R₁ of rotary adsorbent contactor 222. The resulting gas flow 254 is combined with gas stream 266 to leave the system as a waste gas stream. Also shown in the figure is gas stream 256 passing through a heat exchanger 258 to be cooled and as gas stream 260 to pass through cooling zone C₂ of rotary adsorbent contactor 230. Gas stream 262 leaves cooling zone C₂ and is combined with gas stream 242 exiting regeneration zone R₂ to form gas stream 242 as set forth above. Gas stream 264 is diverted from gas stream 228 to cool cooling zone C₁, exiting rotary adsorbent contactor 222 as gas stream 266 and combined with gas flow 254 exiting regeneration zone R₁ of rotary adsorbent contactor 222.

### EXAMPLE 1

A single rotary adsorbent contactor was assembled. It had an outside diameter of 250 mm with a 64 mm hub. The depth of the wheel in the flow direction is 200 mm. The adsorbent media contained UOP MOLSIV DDZ-70. The adsorbent media is nominally 70 wt-% of the DDZ-70 adsorbent, the balance being fibrillated polyaramid fibers and a small amount of organic binder. The adsorbent media is a corrugated structure having cells running parallel to the axis of rotation. The structure has an open face area fraction of about 72%. The adsorbent media density as flat stock has a characteristic density when activated of about 0.83 grams of media per cubic centimeter. The apparent density of the adsorbent portion of the rotary contactor is about 0.224 gram/cubic centimeter.

### EXAMPLE 2

A laboratory test facility was constructed. A blower capable of supplying approximately 4248 standard liters per minute (SLPM) (150 standard cubic feet per minute (SCFM)) at approximately 5 inches of water column head pressure was provided.

A variable damper was used to control the flow. The outlet of the blower and its damper was directed into a humidistat that was used to introduce moisture into the air stream.

The flow rate, temperature, static and dynamic pressure and moisture content of the air stream from the humidistat were measured and controlled.

The rotary contactor of Example 1 was mounted inside a cassette that encloses the contactor, the drive motor, and provides for ducts that direct flows to and away from the faces of the wheel. On the feed air supply side of the wheel one partition separates the feed air from the combined regeneration and cooling waste products. The face areas allotted to these parts of the face are approximately equal.

On the product side of the contactor, the face of the wheel is divided into three chambers. Approximately half the product face of the wheel directs the gross product of the wheel to a cooler and the remaining half is divided equally between a regeneration portion and a cooling portion.

The cassette was mounted immediately downstream of the humidistat and its associated instrumentation.

An air cooler was introduced immediately downstream of the cassette.

Flow meters, temperature sensors and humidity meters were introduced into the test facility to enable us to close mass and heat balances on the adsorbent contactor. Further heaters and control valves were introduced to allow for great flexibility in directing and controlling air flows to and from the wheel.

### EXAMPLE 3

The test facility of Example 2 with the rotary adsorbent contactor of Example 1 was run with the conditions shown in Table I. In the row labeled Observation number 39, an air flow of 2832 SLPM (100 SCFM) was introduced into the humidistat and subsequently into the adsorber section of the contactor. In this example the regeneration flow was ambient air with approximately the same conditions as the stated feed air with the exception that the regeneration air was heated to 151° C. (304° F.). This air was flowing in a direction counter-current to the feed air. The cooling air was taken as a minor portion of the gross product of the adsorbing sector of the contactor. The rotation rate of the adsorbent contactor was 37.89 revolutions per hour. In this example, the contactor removed a major portion of the water contained in the feed air. The final product contained 748 parts of water by volume per million parts of water containing air (ppm(v/v)). Water content of the air was reduced by a factor of 13.25. A net product of 1965 SLPM (69.4 SCFM) was obtained.

### EXAMPLE 4

Example 4 shown in Table I in the row labeled observation 43 also used fresh airs but at an increased flow rate. The contactor's rotation rate was reduced to about 19 revolutions per hour and the temperature of the regeneration air was reduced to 141° C. (286° F.). In this example, the contactor produced about the same net product flow rate but now the moisture content was reduced to 345 ppm(v/v). This represents a reduction of the water content of the air by a factor of 25.79.

### EXAMPLES 5, 6, AND 7

Examples 5-7, shown in Table I in row labeled observation 2, 1, and 9 respectively, used varying feed flows, each at increased moisture content relative to Examples 3 and 4. The regeneration and cooling flows for Example 5 were both taken as minor portions of the gross product of the adsorber. With the use of partial product for regeneration and cooling we were able to reduce the regeneration temperatures to about 139° C. (282 F). Final products varied as the regeneration and cooling flows were varied.

TABLE 1
Case Examples for Low Pressure Rotary Adsorbent Contactors

| | Rotation | Feed | Feed | Yfeed | | Cooling | Regen | Gross | Product | |
|---|---|---|---|---|---|---|---|---|---|---|
| Obs | Rate | Flow | Temp | ppm | Regen | Gas | Temp | Prod. | ppm | BTL |
| No. | 1/hour | SCFM | ° F. | (v/v) | SCFM | SCFM | ° F. | SCFM | (v/v) | wt % |
| 39 | 37.89 | 100 | 87 | 9900 | 53.4 | 24.3 | 303.6 | 69.4 | 748 | 1.58 |
| 43 | 19.15 | 102 | 92 | 8900 | 71.9 | 22.1 | 286.0 | 70.1 | 345 | 2.98 |
| 2 | 18.96 | 82 | 87 | 16600 | 30.4 | 18.0 | 287.6 | 33.0 | 1776 | 4.16 |
| 1 | 18.96 | 84 | 87 | 16500 | 29.0 | 27.5 | 282.2 | 33.2 | 483 | 4.62 |
| 9 | 37.89 | 116 | 84 | 10000 | 51.6 | 25.5 | 210.2 | 43.3 | 759 | 1.83 |

### EXAMPLES 8, 9 and 10

In these examples we added a second contactor, also constructed using MOLSIV™ DDZ-70 with all properties the same as the contactor of Example 1 with the exception that the depth in the flow direction was 400 mm.

Examples 8-10 are provided as demonstrations of the use of two rotary adsorbent contactors in series. In each of these examples we ran the first contactor at 19 revolutions per hour with the indicated feeds shown in Table 2 in rows labeled 62, 53, and 52. The regeneration air was fresh air at conditions essentially the same as the stated feed air. The cooling air for the first contactor was a minor portion of the product from the first adsorber. The gross product of the contactor is the feed air minus the cooling air.

The product air was recorded as 631, 1150 and 1723 ppm (v/v) for Examples 8-10. In each example the product air was cooled back to a condition close to the feed air.

TABLE 2

| | Rotation | Feed | Feed | Yfeed | | Cooling | Regen | Gross | Product |
|---|---|---|---|---|---|---|---|---|---|
| Obs | Rate | Flow | Temp | ppm | Regen | Gas | Temp | Prod. | ppm |
| No. | 1/hour | SCFM | ° F. | (v/v) | SCFM | SCFM | ° F. | SCFM | (v/v) |
| 62 | 19.15 | 111.7 | 86.6 | 8151 | 67.9 | 14.35 | 257.0 | 89.4 | 631 |
| 53 | 19.15 | 115.7 | 86.1 | 9816 | 66.1 | 17.50 | 266.0 | 88.1 | 1150 |
| 52 | 19.15 | 115.6 | 85.3 | 11578 | 67.4 | 21.90 | 266.0 | 81.8 | 1723 |

TABLE 3

| | Rotation | Feed | Feed | Yfeed | | Cooling | Regen | Gross | Product |
|---|---|---|---|---|---|---|---|---|---|
| Obs | Rate | Flow | Temp | ppm | Regen | Gas | Temp | Prod. | ppm |
| No. | 1/hour | SCFM | ° F. | (v/v) | SCFM | SCFM | ° F. | SCFM | (v/v) |
| 62 | 6.0 | 89.4 | 81.4 | 631 | 28.9 | 12.0 | 257 | 48.4 | 1 |
| 53 | 4.0 | 88.1 | 82.2 | 1150 | 13.0 | 12.4 | 257 | 62.7 | 5 |
| 52 | 4.0 | 81.8 | 83.0 | 1723 | 19.6 | 13.4 | 257 | 48.8 | 10 |

The cooled gross product of the first contactor as shown in Table 2 was fed to the adsorber section of the second contactor. The conditions of operation are stated in Table 3 in the rows labeled 62, 53 and 52 respectively. The second contactor used minor portions of the product air of the second contactor for both cooling and regeneration.

The driers operated according to these examples produced net product flows of 1359 to 1776 SLPM (48 to 62.7 SCFM) and yielded water contents of 1, 5, and 10 ppm (v/v) respectively.

These examples demonstrate that two rotary adsorbent contactors operated in series can achieve extremely low water contents.

Although illustrative embodiments of the present invention have been described herein, it is to be understood that the invention is not limited to those precise embodiments, but that various changes and modifications can be effected therein by those skilled in the art without departing from the scope or spirit of this invention.

1. A process of producing a purified compressed gas stream comprising:
a) removing impurities from a gas feed stream by passing said gas feed stream through an adsorption sector of a continuously rotating rotary contactor in a direction parallel to an axis of rotation of said rotary contactor resulting in a purified gas and wherein said rotary contactor comprises an adsorbent material;
b) regenerating said continuously rotating rotary contactor by passing a regenerating gas stream through a regeneration sector of said rotating rotary contactor, wherein said regenerating gas stream is at a higher temperature than said gas feed stream;
c) then passing a cooling stream through a cooling sector of said rotating rotary contactor to prepare said rotating rotary contactor for said gas feed stream to pass through said adsorption portion of said continuously rotating rotary contactor; and
d) compressing said purified gas by passing said purified gas through at least one compressor.

2. The process of claim 1 wherein said regenerating gas stream comprises a gas stream that has a lower impurity content than said gas feed stream.

3. The process of claim 1 wherein said regenerating gas flow is co-current to the direction of said gas feed stream.

4. The process of claim 1 wherein said regenerating gas flow is counter-current to the direction of said gas feed stream.

5. The process of claim 1 wherein said cooling gas flow is cocurrent to the direction of said gas feed stream.

6. The process of claim 1 wherein said cooling gas flow is countercurrent to the direction of said gas feed stream.

7. The process of claim 1 wherein said regenerating gas flow is a portion of said purified gas that is diverted to become the regenerating gas flow and is then heated to an appropriate temperature to function as a regenerating gas.

8. The process of claim 1 wherein said cooling gas flow is a portion of said purified gas that is diverted to become the cooling gas flow and is then cooled as necessary to an appropriate temperature to function as a cooling gas.

9. The process of claim 1 wherein said cooling gas flow and said regenerating gas flow are both flowing countercurrent to said gas feed stream.

10. The process of claim 1 wherein said purified gas comprises less than 200 ppm water vapor.

11. The process of claim 1 wherein said purified gas comprises a gas selected from the group consisting of air, light hydrocarbons, nitrogen, carbon dioxide and oxygen.

12. The process of claim 1 wherein said impurities removed from said gas feed stream comprise one or more of the following gases selected from the group consisting of nitrous oxide, light hydrocarbons, carbon dioxide, light sulfur compounds, hydrochloric acid, mineral acids and water vapor.

13. The process of claim 1 wherein the said compression of said purified gas generates heat that is used to warm said regenerating gas flow.

14. The process of claim 1 wherein the regenerating gas stream comprises a portion of the purified gas stream.

15. The process of claim 1 wherein the cooling gas stream comprises a portion of the purified gas stream.

16. A process of producing a dried gas stream containing less than 200 PPM of water comprising:
a) removing water from a gas feed stream by passing said gas feed stream through an adsorption sector of a continuously rotating rotary contactor in a direction parallel to an axis of rotation of said continuously rotating rotary contactor resulting in a dried gas containing less than 200 PPM of water wherein said rotary contactor comprises an adsorbent material;
b) regenerating said continuously rotating rotary contactor by passing a regenerating gas stream through a sector of said rotating rotary contactor wherein said regenerating gas stream is at a higher temperature than said gas feed stream; and
c) passing a cooling stream through a cooling sector of said rotating rotary contactor to prepare said rotating rotary contactor for said gas feed stream to pass through said adsorption portion of said continuously rotating rotary contactor.

17. The process of claim 16 wherein said dried gas stream contains less than 100 ppm of water.

18. The process of claim 16 wherein said dried gas stream contains less than 25 ppm of water.

19. The process of claim 16 wherein said gas feed stream is air.

20. The process of claim 16 wherein said regenerating gas flow is counter-current to the direction of said gas feed stream.

21. The process of claim 16 wherein said cooling gas flow is cocurrent to the direction of said gas feed stream.

22. The process of claim 16 wherein said cooling gas flow is countercurrent to the direction of said gas feed stream.

23. The process of claim 16 wherein said gas feed stream is dried prior to compression of said dried gas.

24. A process for purification of a gas feed stream comprising first passing a gas feed stream containing at least one impurity across an adsorption zone of a first continuously rotating rotary adsorbent contactor to produce a partially purified product gas; passing said partially purified product gas across an adsorption zone of a second continuously rotating rotary adsorbent contactor to further purify said partially purified product gas and to produce a highly purified product gas.

25. The process of claim 24 wherein both rotary adsorbers consist of adsorption, regeneration and cooling sector.

26. The process of claim 25 wherein a regeneration stream flowing through the regeneration sector of the second continuously rotating rotary adsorbent contactor comprises a heated portion of the highly purified product gas, and a cooling stream flowing through the cooling sector of the second continuously rotating rotary adsorbent contactor comprises a cooled portion of the highly purified product gas.

27. The process of claim 26 wherein the regeneration stream for the first continuously rotating rotary adsorbent contactor comprises the effluent streams from the cooling and regeneration sectors of the second continuously rotating rotary adsorbent contactor.

28. The process of claim 27 wherein the regeneration stream for the first continuously rotating rotary adsorbent contactor further comprises a stream having the same composition as the gas feed stream.

29. The process of claim 24 wherein the gas feed stream is air.

30. The process of claim 24 wherein at least one impurity is water.

31. The process of claim 24 further comprising passing said highly purified product gas across an adsorption zone of a third continuously rotating rotary adsorbent contactor to further purify said highly purified product gas to produce an ultra high purity product gas.

32. The process of claim 24 comprising passing the partially purified product gas of the first continuously rotating rotary adsorbent contactor across a heat exchanger to cool said partially purified product gas prior to contact of said partially purified product gas with said second continuously rotating rotary adsorbent contactor.

33. The process of claim 24 wherein said first and said second continuously rotating rotary adsorbent contactors each comprise at least one adsorption sector, at least one regenerating sector and at least one cooling sector.

34. The process of claim 24 wherein said first continuously rotating rotary adsorbent contactor comprises an adsorption zone and a regeneration zone.

35. The process of claim 31 wherein said first continuously rotating rotary adsorbent contactor is contacted with a regenerating stream that is either lower in water content or lower in temperature than said gas feed stream and wherein there is no cooling zone on said first continuously rotating rotary adsorbent contactor.

36. The process of claim 24 wherein said second continuously rotating rotary adsorbent contactor comprises an adsorbent that is selective for removal of water from a gas stream.

37. The process of claim 24 wherein said second continuously rotating rotary adsorbent contactor is selective for removal of carbon dioxide from a dry gas.

38. The process of claim 31 wherein said third continuously rotating rotary adsorbent contactor is selective for removal of carbon dioxide from a dry gas.

39. The process of claim 24 further comprising compression of said purified gas by passing said purified gas through at least one compressor.

40. The process of claim 31 further comprising compression of said purified gas by passing said purified gas through at least one compressor.

41. The process of claim 40 wherein said compression of said purified gas generates heat that is used to warm at least one regenerating gas flow.

42. The process of claim 40 wherein said compression of said purified gas generates heat that is used to warm at least one regenerating gas flow.

43. A system for purifying and compressing a gas feed stream, said system comprising:
a) an inlet for a gas feed stream to convey said gas feed stream to at least one rotary adsorbent contactor comprising at least one adsorbent material to remove at least one impurity from said gas feed stream;
b) connecting means to send said gas feed stream from said rotary adsorbent contactor to a gas compressor; and
c) said gas compressor.

44. The system of claim 43 wherein said rotary adsorbent contactor rotates around an axis of rotation, and wherein said gas feed stream flows in a direction parallel to said axis of rotation through at least one adsorbent sector of said rotary contactor, wherein said impurities are adsorbed within said adsorbent sector of said rotary contactor and wherein a regenerating gas flows through at least one regeneration sector of said rotary contactor, wherein said impurities are desorbed within said second sector of said rotary contactor.

45. The system of claim 44 further comprising a cooling sector of said rotary contactor wherein a flow of gas having a cooler temperature than at least one of the adsorbent sector or the regeneration sector is passed through said cooling sector of said rotary contactor.

46. The system of claim 44 wherein said regenerating gas flow is co-current to the direction of said gas.

47. The system of claim 44 wherein said regenerating gas flow is counter-current to the direction of said gas.

48. The system of claim 44 wherein said compressed gas is sent to an air separation plant to separate said compressed gas into nitrogen, oxygen and other gases.

49. The system of claim 44 wherein said system produces purified, compressed air is an instrument air drying system.

50. The system of claim 44 wherein said system produces purified, compressed air for an air brake system in a vehicle.

51. The system of claim 44 wherein said adsorbent material is selected from the faujasite, silica gel, alumina and mixtures thereof.

52. The system of claim 51 wherein said faujasite is in the sodium, rare earth, calcium, ammonium, or hydrogen form, or mixtures thereof.

53. The system of claim 44 further comprising a downstream adsorbent wheel located downstream from said compressor to further purify said compressed gas and means to conduct flow of said compressed gas from said compressor to said downstream adsorbent wheel located downstream from said compressor.

54. The system of claim 44 further comprising a second rotary adsorbent contactor to further purify said gas stream.

55. The system of claim 54 further comprising a third rotary adsorbent contactor comprising at least one adsorbent material to produce an ultra high purity product gas.
